(19) United States
(12) Patent Application Publication
(10) Pub. No.: US 2002/0152216 A1
(43) Pub. Date: Oct. 17, 2002

(54) Method and system for optimizing consultations of groups of data by a plurality of clients

(76) Inventor: Nicolas Bouthors, Meylan (FR)

Correspondence Address: Robert M. Angus, Westman, Champlin & Kelly, Suite 1600, International Centre, 900 Second Avenue South, Minneapolis, MN, 55402-3319, US

(21) Appl. No.: 09/965,634

(22) Filed: Sep. 27, 2001

(30) Foreign Application Priority Data
Sep. 29, 2000 (FR) 00 12492

(51) Int. Cl. G06F 17/30

(52) U.S. Cl. 707/10

(57) ABSTRACT

The invention relates to a method for consulting data on at least one terminal (100) by at least one user, wherein the data consulted (200) are pages downloaded from remote sites (101) and/or available on a data recording medium. A personalization stage implements at least one annotation database that is independent of the pages. The personalization stage associates at least one reference data item, which is capable of being detected among the consulted data, with at least one annotation. A search is conducted for at least one reference data item (202, 203) in at least a portion of the pages (200). When one of the reference data items is detected in the search stage among the consulted data, the associated annotation (300) in the annotation database is systematically proposed to the detected reference data item (202, 203).

### FIELD OF THE INVENTION

The invention relates to the field of data consultation on a client terminal, such as a radiotelephone or PC, the data being provided from any medium, particularly a removable recording medium or a communications network for example.

More precisely, the invention relates to optimizing consultation of groups of data by a plurality of clients and in particular suiting the data to a particular client (user).

### BACKGROUND OF THE INVENTION

In particular the communications network can be, although not exclusively, an Internet-type network such as the worldwide Web. In this event the data is downloaded from access links that are URLs linking to Web pages.

In addition, the present invention not only applies when the terminal has direct access to the communications network but also when it has access via at least one other telecommunications network to which it is subscribed. The other telecommunications network is, for example, the Switched Telephone Network (fixed network) or a radio communications network (mobile network).

A radio communications network, for example, uses the GSM (Global System for Mobile communications) standard or an equivalent or rival standard such as DCS 1800 (Digital Cellular 1800 MHz), PCS 1900 (Personal Communications System 1900 MHz), DECT (Digital European Cordless Telecommunications), GPRS (General Packet Radio Service) or UMTS (Universal Mobile Telecommunications System).

In order to show the drawbacks of the prior art in terms of consulting data the principles are described below of the present technique for consulting data from a Web page within the Internet. A Web page is usually associated with a site (home page) or part of a site (other page(s) of the site). Each Web page may also match a service offered by a site.

Obviously the drawbacks described below using an illustrative example are common to other data consultation techniques of the prior art.

It is assumed that the clients in question access a telecommunications network interconnected to the Internet. They request connection via their terminal (or network installation) from their provider who then ensures communication between the clients' terminal and the Internet. Once communication has been established clients can access various Web pages according to a client-server mode. In order to access Web pages clients have a client software included in their terminal, in other words a browser that, in particular, has a direct and an indirect operating mode.

In the direct operating mode the browser uses the URL addresses known to the user and communicates directly with the browser.

In the indirect operating mode the browser uses hypertexts (or hyperlinks) contained in another Web page that is displayed on the terminal screen. Each hyperlink comprises a URL address and a hypertext link zone (image and/or text) contained in the Web page displayed on the terminal screen.

Once clients have provided a URL address either directly by typing on the keyboard (direct mode) or indirectly by clicking on a hypertext link zone of a Web page of their choice (indirect mode) the browser emits a request containing the matching URL address. In both configurations the access link that constitutes the URL address is considered as being activated.

The request is received by the server containing the requested Web page, i.e. the URL address of which has been provided, in order for the server to send the Web page via the network in a special language known as HTML (Hypertext MarkUp Language). This language contains instructions (tags) informing the browser on the client terminal how to organize the Web page when it arrives.

The standard use of URL addresses as described above presents several drawbacks and does not meet all requirements.

Firstly, the information is presented according to criteria specific to the author of the pages of consulted data and does not take clients' requirements into consideration. Therefore, the author of the pages of data consulted may provide details of a point that is of no interest to the client yet only provide a brief outline of a point that is important to the client.

More often than not the information provided by the pages of data consulted is also subjective. Clients have no critical means available of determining the interest and quality of the site or the pages consulted or of forming an opinion about the data consulted.

Furthermore, when clients want to obtain information from a Web site they do not know they can use search engines with key words but these aids only assist the search; clients are often faced with a problem of identifying suitable key words that will enable them to access the required data as efficiently as possible. The result of a search is often unsuited to the clients' request that can obtain an inextricable multitude of references of varying interest or only very few or no references whatsoever. Clients therefore have great difficulty in obtaining the relative data they require.

The above, which concerns consulting data from the Web, clearly applies more generally to the consultation of all types of information, particularly consultation of data on a removable recording medium such as a CD-ROM or DVD-ROM.

Also the standard use of URL addresses does not automatically filter data that is relative for a client.

A particular aim of the invention is to overcome the various drawbacks of the prior art.

More precisely, one of the aims of the present invention is to provide a technique for consulting data on a recording medium and/or a communications network that is suited to each, or at least certain clients.

Another aim of the invention is to provide a client with data selected for the particular client according to his/her requirements, selections, instructions, etc.

A further aim of the invention is to take into consideration the data consulted and to propose related additional data on the fly.

Another aim of the invention is to provide such a technique that is both simple to implement and inexpensive.

Yet another aim of the invention is to provide such a technique one of the embodiments of which does not require any modification of the client terminals.

A further aim of the invention is to enable the Internet site operator or manager to provide a high added-value service.

### SUMMARY OF THE INVENTION

These various aims and others described below are achieved according to the invention using a method for consulting data on at least one terminal by at least one user, the consulted data being pages downloaded from remote sites and/or available on a data recording medium and is remarkable in that it comprises a stage for personalizing pages implementing at least one annotation database that is independent of the pages, the actual personalization stage comprising the following stages:

associating at least one reference data item, which is capable of being detected among the consulted data, with at least one annotation in the annotation database;

searching for at least one reference data item in the pages or in at least a portion of the pages; and

when one of the reference data items is detected during the search stage of consulted data, systematically proposing the at least one associated annotation in the annotation database to the detected reference data item.

“Page” refers not only to a Web page but more generally to any type of computer document containing text and/or image and/or sound data.

“Data recording medium” refers particularly, although not exclusively, to CD-ROMs, diskettes, hard discs of client installation, etc.

It should be noted that “annotation database” can include annotations and/or annotation references, particularly URL addresses or indexes in an annotation table.

The invention therefore enriches consulted data with relevant annotations that are proposed, for example, on the fly.

According to one particular characteristic the consultation method is remarkable in that the stage in which at least one reference data item is associated with at least one annotation comprises a stage in which one semantic link criterion, which consists of at least one reference word, is associated with each annotation of the annotation database; and in that the search stage comprises a search stage of at least one semantic link of the semantic link criterion to the reference data item likely to be detected among the consulted data.

Therefore, the data is advantageously enriched with the semantic link bases, i.e. with the actual meaning of the consulted data.

According to one particular characteristic, the consultation method is remarkable in that the stage in which at least one reference data item is associated with at least one annotation comprises a stage in which the annotation database is constructed using data provided by at least one annotation creator.

The data that is “provided” is understood to refer to data that is:

actually provided on the initiative of an annotation creator; and/or

collected from an annotation creator.

Therefore, the annotations are provided by an annotation creator that is generally independent of the remote site from which the consulted data comes. The consulted data can thus be advantageously enriched with annotations that are critical and/or that have high added value.

According to one particular characteristic, the consultation method is remarkable in that the proposal stage comprises at least one of the following stages:

indicating the possibility of providing an associated annotation to the at least one of the reference data items detected in the search stage;

on request from the user, providing, in the strict sense of the term, an annotation associated with at least one reference data item detected in the search stage.

Advantageously, each annotation is therefore proposed to the user of the terminal before it is presented or directly presented, the user then having the possibility of refusing the annotation. This results in a high degree of flexibility of use.

According to one particular characteristic, the consultation method is remarkable in that it also comprises the following stages for each user:

defining a user profile enabling the annotations made available to the user to be limited to selected annotations included in a specific selection group comprising annotations of possible interest to the user; and

selecting annotations according to the user profile such that only the selected annotations are proposed to the user in the proposal stage.

Therefore, as the profile can, in particular, define an identifier of users and/or their subjects of interest the annotations are advantageously personalized according to each terminal user for whom they are intended.

According to one particular characteristic, the consultation method is remarkable in that it also comprises a stage in which an annotation sub-database is constructed for each user that comprises only the annotations selected according to the user profile.

Therefore, the size of the database to be transmitted to the user is advantageously reduced, even though in some configurations only the references to the annotations are transmitted, giving shorter transmission times and quicker processing than if the entire database were to be transmitted and the filtering performed by the terminal, even though the latter possibility is not excluded and is an integral part of the invention.

According to one particular characteristic, the consultation method is remarkable in that the profile of each user takes into consideration at least one of the following attributes:

at least one profile of an annotation creator capable of providing data intended to be used to construct an annotation base in the construction stage;

at least one annotation domain; and

at least one profile of an annotation provider.

Therefore, a profile of an annotation creator or annotation providers can contain identification and/or qualification information from the annotation creator or provider concerned about a particular subject, information concerning the domains processed, etc. The user or an intermediary, e.g. an access provider, can therefore advantageously choose or select annotation creators or annotation providers according to certain criteria and/or select them from a list.

According to one particular characteristic, the consultation method is remarkable in that it also comprises the following stages:

putting at least one user and one annotation provider in contact with each other via an annotation service provider; and

authorizing at least one user access to all or part of the annotation database.

Therefore, the presence of an intermediary advantageously facilitates user access to an annotation provider. Access may also be subject to authorization which, in certain situations, could enable annotations to be confidential. This also offers the possibility of subscription which, in particular, enables annotations to be provided that have commercial value.

According to one particular characteristic, the consultation method is remarkable in that the terminal implements the following:

the annotation database; and/or

the annotation sub-database of the terminal user; and/or

at least one of the following stages:

the search stage;

the semantic link stage;

the proposal stage; and

the stage in which at least one terminal user profile is defined.

Therefore, the terminal advantageously implements a certain number of stages that, as they are processed locally, enable in particular the above operations to be performed rapidly and an annotation proposal to be made virtually instantaneously.

According to one particular characteristic, the consultation method is remarkable in that the consulted data is downloaded via at least one first communications network and/or is available on a data recording medium.

Therefore, the annotations can be proposed advantageously irrespective of the origin of the consulted data and particularly if the data is emitted from a network, such as an Internet-type network in the widest sense, or a data recording medium, for example a CD-ROM or DVD-ROM.

According to one particular characteristic, the consultation method is remarkable in that a remote installation connected to the terminal via at least a second communications network that is identical to or different from the first communications network implements the following:

the annotation database; and/or

the annotation sub-database of the terminal user; and/or

at least one of the following stages:

the search stage;

the semantic link stage;

the proposal stage; and

the stage in which at least one terminal user profile is defined.

Therefore, a remote installation connected to the terminal via a second communications network advantageously implements a certain number of stages that, as they are processed remotely, enable, in particular, the annotations to be updated in real time or on a regular basis.

According to one particular characteristic, the consultation method is remarkable in that the remote installation belongs to the group comprising the following:

annotation provider servers;

annotation service provider servers; and

proxy installations included in the second communications network.

Therefore, the remote installation is advantageously a prioritized installation that is easily accessible by any user and particularly by a client of an annotation provider and/or annotation service provider that, typically, is a remote service provider and can, in particular, be an access or Internet service provider.

According to one particular characteristic, the consultation method is remarkable in that the first communications network and/or the second communications network is(are) Internet-type network(s) (Web, WAP or derivatives).

Therefore, the networks concerned by the invention are advantageously Internet-type networks in the widest sense, such as the Web and WAP networks and all their derivatives, said networks lending themselves particularly well to providing remote services and/or information.

According to one particular characteristic, the consultation method is remarkable in that an annotation service provider implements the following:

the annotation database; and/or

the annotation sub-database of the terminal user; and/or

at least one of the following stages:

the stage in which at least one reference data item is associated with at least one annotation;

the search stage;

the proposal stage;

the semantic link stage;

the stage in which at least one terminal user profile is defined;

the stage in which contact is established; and

the access authorization stage.

Therefore, an annotation service provider advantageously implements a certain number of stages that, as they are processed remotely by the annotation service provider, enable, in particular, the annotations to be updated in real time or on a regular basis by the service provider itself which enables the processing to be transparent to the terminal user

The invention also relates to a system for consulting data on at least one terminal by at least one user, the consulted data being pages downloaded from remote sites via at least a first communications network and/or available on a data recording medium, characterized in that it comprises means for personalizing pages implementing at least one annotation database that is independent of the pages, the actual personalization means comprising the following stages:

means for associating at least one reference data item, which is capable of being detected among the consulted data, with at least one annotation in the annotation database;

means for searching for at least one reference data item in the pages or in at least a portion of the pages; and

when one of the reference data items is detected in the search among consulted data, means for systematically proposing the at least one annotation in the annotation database associated with the detected reference data item.

According to one particular characteristic, the data consultation system is remarkable in that an annotation service provider implements at least certain association, search and/or proposal means in order to provide the user(s) of the terminal(s) with an annotation service.

According to one particular characteristic, the data consultation system is remarkable in that the annotation service provider comprises means for providing the user with at least certain of the following means via a second communications network that is identical to or different from the first network:

all or part of the annotation database;

at least one of the search means; and

at least one of the proposal means.

The particular characteristics and advantages of the data consultation system are the same as those of the data consultation method and are not therefore repeated.

### BRIEF DESCRIPTION OF THE DRAWINGS

Other characteristics, aims and advantages of the present invention will be better understood from the following description of a preferred embodiment of the invention. The description is of a non-limitative example and refers to the attached figures where:

FIG. 1 is a schematic representation of a network according to a particular embodiment of the invention;

FIG. 2 is a data consultation screen according to a particular embodiment of the invention;

FIG. 3 is a data consultation screen showing an annotation according to a particular embodiment of the invention;

FIG. 4 is a schematic representation of the consultation of an operator site proposing an annotation service according to a particular embodiment of the invention;

FIG. 5 is a communications protocol enabling an annotation database to be updated according to a particular embodiment of the invention;

FIG. 6 is a communications protocol enabling an annotation proposal to a client to be implemented according to a particular embodiment of the invention;

FIG. 7 is a schematic representation of a first modification of a network according to a particular embodiment of the invention;

FIG. 8 is a communication protocol enabling an annotation proposal to a client to be implemented in the first modification according to a particular embodiment of the invention.

### DETAILED DESCRIPTION OF THE PREFERRED EMBODIMENTS

The general principle of the invention is based on personalizing data as pages, said data being displayed and/or recorded on a client terminal. The data is:

downloaded from remote sites via, for example, an Internet; and/or

available on a data recording medium such as a CD-ROM, DVD-ROM or diskette.

An annotation provider first builds up a database comprising annotations. Reference data, for example semantic link criteria consisting of reference words, are associated with each annotation included in the database.

In one modification, the database does not include the actual annotations but references to the annotations that may be downloaded if required.

Parameters characterizing each annotation, such as its field of application, for example sport, economy, travel, etc., a specific theme, for example the Olympic Games, a football team, etc., the type, for example text, image, sound recording, newspaper extract, hypertext link, etc., a creation date or update, the original author and possibly the profile of said author, for example an expert in the field, journalist, any member of a given company or organization, can also be associated with the annotations of the database.

A client can then subscribe to an annotation service, particularly with an annotation provider via an annotation service provider. The annotation service provider can be a telecommunications operator or an Internet access provider. During the subscription operation clients can define their profiles by specifying their interests, particularly the field, specific theme, profile of the annotation creator, etc.

In one modification, clients take out a subscription directly from the annotation service provider. Their profiles can also then include an annotation provider profile.

In general, clients are able to update their profiles whenever they want or following any type of event.

Then an annotation database, which is extracted from a complete annotation database but only contains annotations filtered according to the client's profile, and a software package are downloaded from the annotation provider onto a client terminal.

When the client terminal displays the data the software package searches the displayed data for the reference data included in the annotation database that has been downloaded.

When a reference data item is detected the software package:

proposes the annotation(s) in the annotation database associated with the detected reference be displayed to the client (the client is then free to accept or refuse the annotation display); and/or

displays the annotation(s) in the annotation database associated with the detected reference.

In one modification, when the consulted data is transmitted via a network a proxy performs the search operations for reference data in the consulted data taking into consideration an annotation database downloaded from an annotation provider to which the client subscribes and the client's profile. When the proxy detects a reference data item that is compatible with the client's profile it inserts the following in the consulted data:

an annotation proposal associated with the reference data item detected; and/or

an annotation associated with the reference data item detected.

In one modification, the annotation database does not, strictly speaking, consist of annotations but of annotation references. Therefore, when it is necessary to display an annotation the annotation is downloaded from the reference specified in the annotation database; the reference is, for example, an address referring to the annotation or an index in an annotation table.

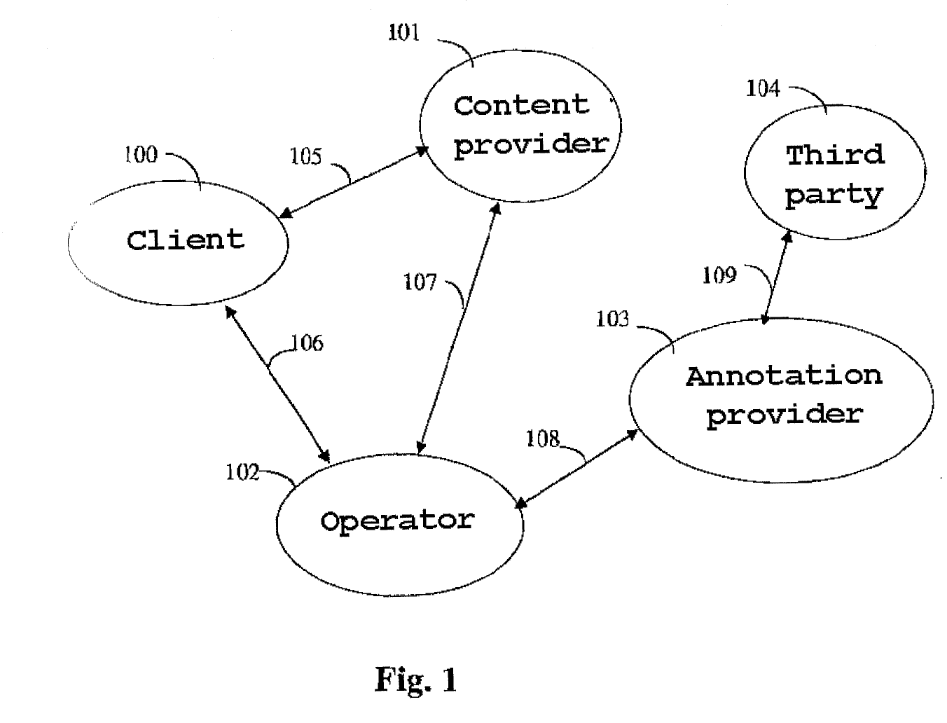

A telecommunications network infrastructure is presented relative to FIG. 1 that enables the invention to be implemented.

The infrastructure includes the following:

a client terminal 100;

a content provider Internet site 101;

an operator installation 102;

an annotation provider installation 103;

a third-party terminal 104.

Client terminal 100 and third-party terminal 104 are terminals of any type, for example computer and/or mobile terminal.

Client terminal 100 can access a content provider Internet site 101 via any link 105. In particular, client terminal 100 can therefore consult data from site 101.

Client terminal 100 is also connected via a link 106 to an operator installation 102 that, in particular, enables it to download data or tools for processing data and display.

Operator installation 102 is connected to site 101 via a link 107 that enables it to possibly download any data.

Operator installation 102 is also connected to annotation provider installation 103 via a link 108 that enables it to download data and tools for processing data and display.

Annotation provider installation 103 is connected to a third-party terminal 104 via a link 109 that enables third-party terminal 104 to provide data to installation 103.

Links 105, 102, 107, 108 and 109 are links of any type of communication, particularly links included in a Switched Telephone Network (STN), Internet-type links and/or links belonging to a radio communications network, for example according to standard GSM or other.

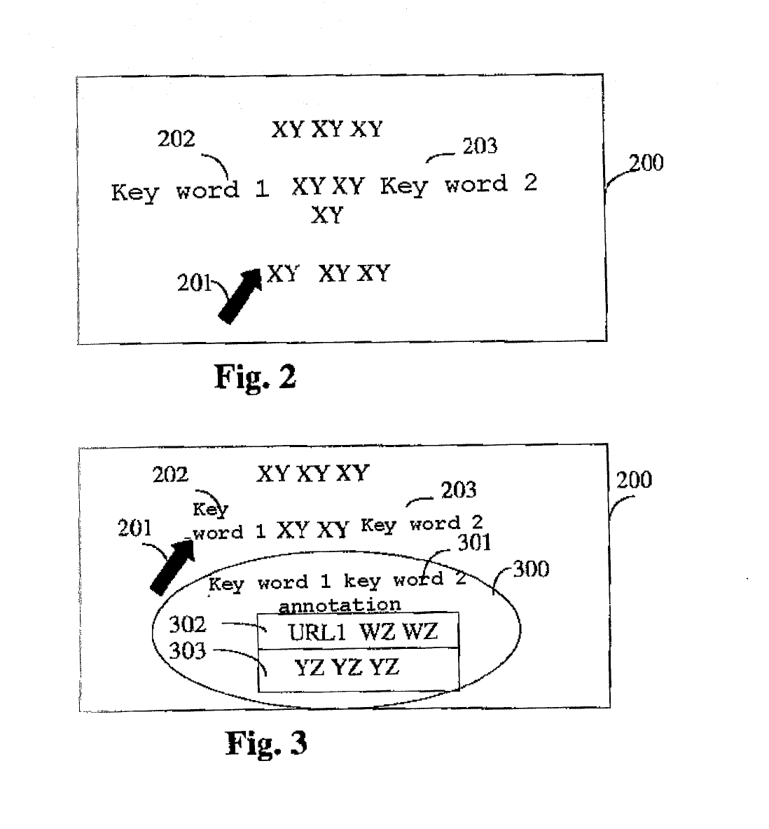

FIG. 2 is a schematic representation of a terminal screen 200 such as client terminal 100 as it appears when a site 101 is consulted.

A text is displayed on screen 200 containing data from site 101 and a pointer 201 controlled, for example, by a computer mouse.

In particular, the text comprises a first key word 202 and, nearby, a second key word 203.

In FIG. 2 pointer 201 is assumed to be relatively remote from key words 201 and 202.

As pointer 201 is relatively remote from key words 201 and 202 the only data to appear on the screen is that from site 101. It should be noted that the screen is identical when the data from site $$$201$$$ is consulted without implementation of the invention.

FIG. 3 is a schematic representation of a similar screen 200 to that described relative to FIG. 2.

In FIG. 3 pointer 201 is close to key words 202 and 203.

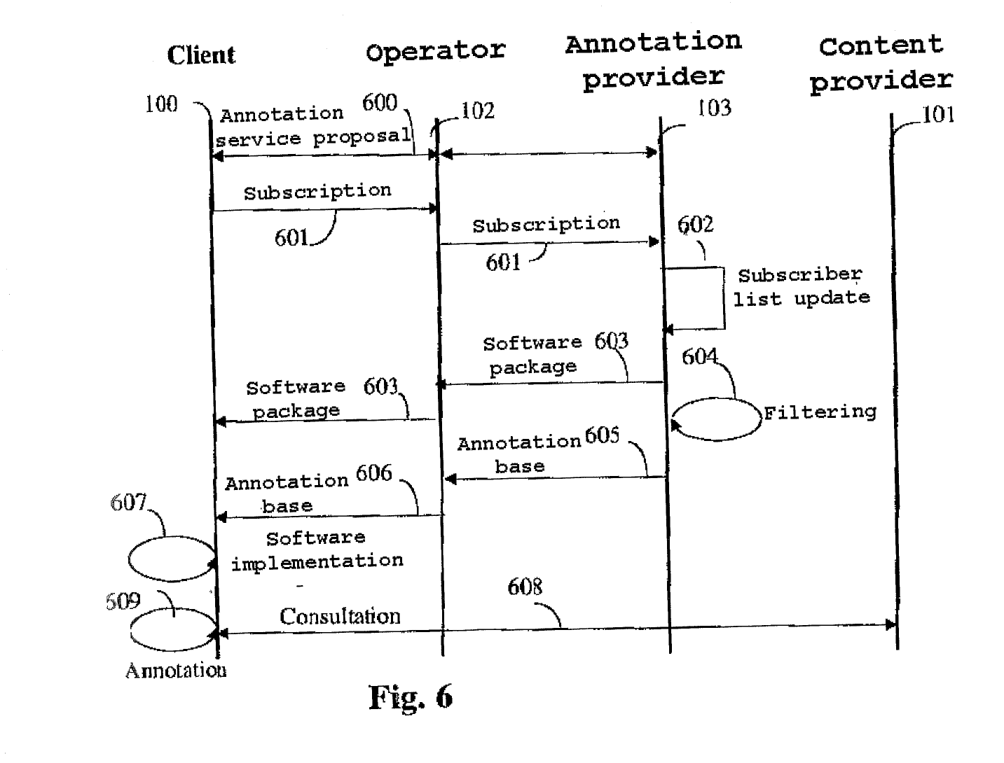

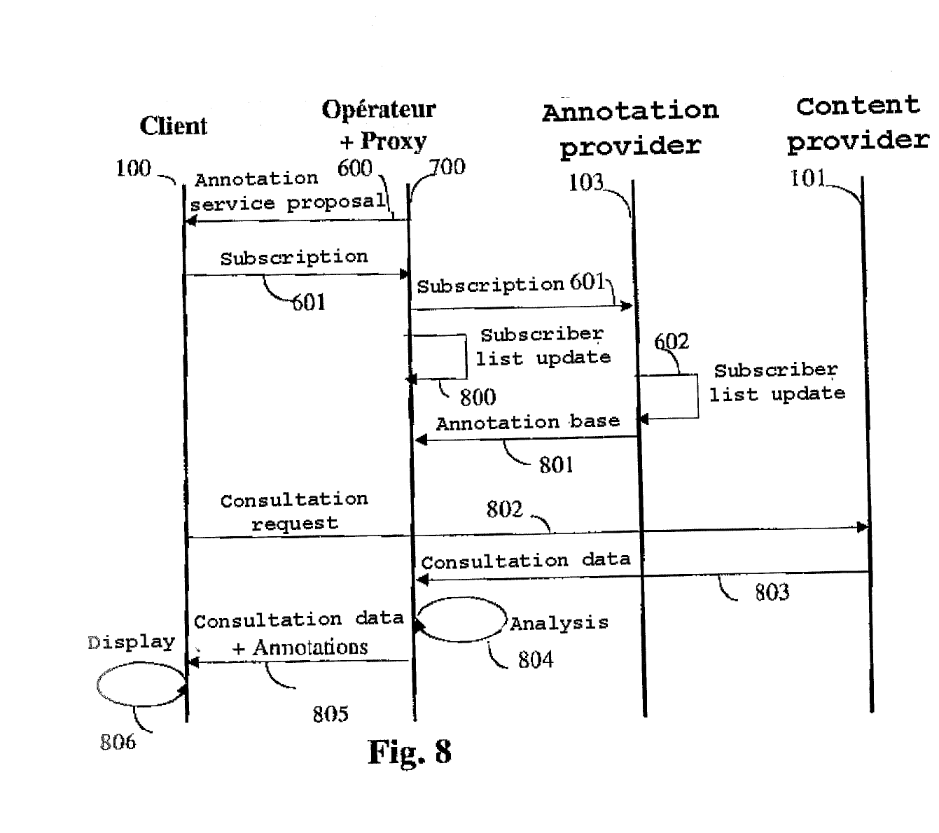

Consequently, an annotation 300 is displayed on screen 200 in an annotation proposal operation described relative to FIGS. 6 or 8.

In particular, annotation 300 comprises the following:

a title 301 clearly indicating that it is an annotation relative to key words 202 and 203 displayed on the screen and near pointer 201;

an Internet site address 302 relative to key words 202 and 203;

data 303 relative to key words 202 and 203.

It should be noted that data 303 is of any type and is, for example, text-, image- or multimedia-type data.

Address 302 includes a hyperlink to any Internet site, for example a Web- or WAP- (Wireless Application Protocol) type site.

Annotation 300 is from an annotation database in annotation provider installation 103 and has been transferred to client terminal 100 via operator installation 102.

In a first modification, the position of pointer 201 relative to the positions of key words 202 and 203 is not taken into consideration and annotation 300 is displayed as soon as key words 202 and 203 appear on the screen or near each other or within the same zone of the screen.

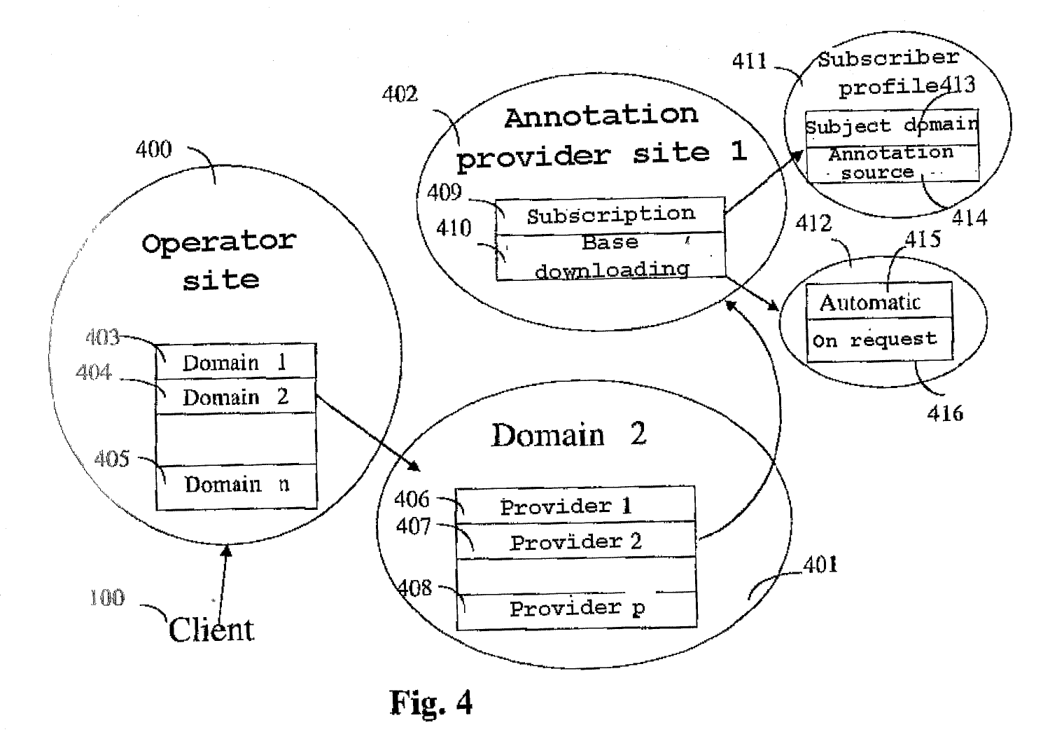

FIG. 4 is a schematic representation of client terminal 100 consulting an operator site 400 that is implemented by installation 102 and that proposes an annotation service.

Site 400 is an Internet-type site and includes hyperlinks to other sites, files or data.

When client terminal 100 consults site 400 via link 106 operator installation 102 proposes several subject domains 403, 404 and 405 of interest to the client that the client may select. The operator in charge of site 400 may propose, for example, travel-, economy-, sport-, cinema-, etc. type subject domains. Each domain proposed is connected by a hyperlink to a matching page.

Therefore, if the client selects domain 404 a page 401 linked to domain 404 will be proposed.

Page 401 contains proposals 406, 407 and 408 from annotation providers relative to domain 404 previously selected.

If, for example, the domain selected is that of sport the matching annotation providers could be, for example, sports newspapers.

Each proposal 406 to 408 is linked by a hyperlink to a page 402 on a site provided by a matching annotation provider installation 103.

In particular, page 402 comprises the following:

a proposal 409 for subscribing to an annotation service or for registering with an annotation service;

a proposal 410 for downloading an annotation database.

It should be noted that the annotation database that is downloaded comprises the actual annotations and/or references to such annotations.

If the clients select subscription proposal 409 installation 103 provides them with a page 411 defining a subscriber profile, said profile comprising, in particular, the following:

a definition of the subscriber's subject domains;

a definition of the sources of annotations requested by the subscriber.

In page 411 a proposal 413 is used to define or complete the subscribers' profiles specifying the exact fields of interest of the clients that will enable the annotations with which they will be provided to be filtered. Otherwise, unless clients define their exact fields of interest annotation provider installation 103 will not filter any annotations. In the sport-type annotation provider domain the fields of interest could be extremely varied and include, for example, a particular sport such as football, a type of competition such as the Olympic Games, famous sports personalities, training methods, sport equipment suppliers, etc.

In page 411 a proposal 414 is used to define or complete the subscriber profile by filtering the sources of annotations, such as those from a third party 104. The client may only be interested in information from named people, from people belonging to or, on the contrary, not belonging to, a specific category such as the category of journalists or famous sports personalities. Otherwise, unless clients define their exact sources of annotations, annotation provider installation 103 will not filter any annotations.

Clients download an annotation database the first time they use the service of an annotation provider. The client can then select proposal 410 for downloading a database which causes a menu 412 to be displayed that, in particular, comprises a proposal 415 for automatic downloading and a proposal 416 for downloading on request. Therefore, an annotation database, i.e. a database containing the actual annotations or annotation references, can be downloaded a first time via link 108 then be automatically updated after proposal 415 has been validated or on request after proposal 416 has been validated.

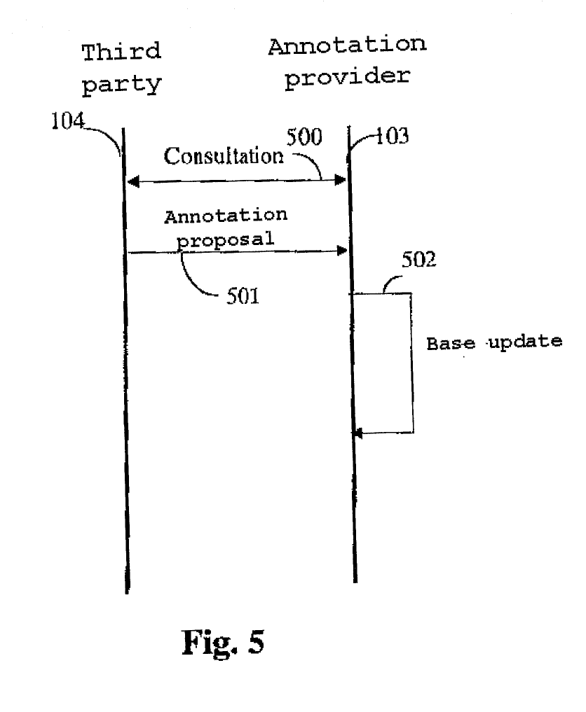

FIG. 5 is a communications protocol that enables an annotation database to be updated in a annotation provider installation 103 by a third-party terminal 104.

During consultation 500 of annotation provider site 402 by a third party a possibility is offered to third-party terminal 104 of providing a data item that could be used as an annotation base.

Therefore, third-party installation 104, referred to as annotation creator, performs an annotation proposal 501 to annotation provider installation 103.

If the data provided by terminal 104 is of interest to the annotation provider, annotation provider installation 103 performs a formatting operation in an update operation 502 to obtain an annotation that it stores in an annotation database with relative information, such as the type of matching annotation creator, the domain and the exact subject of the annotation that will enable subsequent filtering according to these criteria.

In one modification, consultation operation 500 and proposal operation 501 are replaced by a collection operation in which data used to create the annotations is collected directly from an annotation creator on the initiative of the annotation provider.

FIG. 6 is a communication protocol used to implement the annotation proposal made to client terminal 100, as shown relative to FIG. 1.

In an operation 600 operator installation 102, via site 400 shown relative to FIG. 4, and annotation provider installation 103, via site 402, propose an annotation service to client terminal 100.

In an operation 601, client terminal 100 takes out an annotation service subscription from annotation provider installation 103 via operator installation 102 and defines, if appropriate, its profile by selecting proposal 413 and/or 414. There may be a charge for the annotation service or it may be free. If there is a charge a payment operation is performed according to any mode of payment.

Then, in an operation 602, annotation provider installation 103 updates its database containing a list of subscribers.

In an operation 603 an annotation software is then downloaded from annotation provider installation 103 to client terminal 100 via operator installation 102. The annotation software is suited to implementation on terminal 100 and enables the dynamic proposal of annotations by permanently or temporarily polling the data displayed on the user's screen.

In one modification, the annotation software is provided directly by installation 102 to client terminal 100. It should be noted that this operation is only necessary if client terminal 100 does not already have the annotation software. The operator knows whether the client terminal is already subscribed to any annotation service it manages. If this is the case client terminal 100 already has the annotation software and operation 603 is optional. In this modification the method is used that is described in the patent application entitled “Method for optimizing data consultation using an architectural element of the network” that was filed on the same day as the present application by the same applicant. The text of this other application is included in the present document as a reference. It should be noted however that according to the method a part of the network infrastructure inserts an active code on the fly within the consulted data that is transmitted via said element. The active code is a code that enables an algorithm and/or instructions to be performed by the user's terminal. In particular, the active code can be:

a script code interpreted by a browser on the terminal;

a script code “include” interpreted by a browser;

a browser object;

a browser object application;

an applet;

an applet application; or

one or more instruction macros.

In an operation 604 annotation provider installation 103 then creates a filtered annotation database extracted from a complete annotation database that only comprises the following:

annotations matching the profile of client terminal 100 defined in the subscription to the annotation service; and

the associated key words.

In an operation 605 the filtered annotation database is then downloaded from annotation provider installation 103 to operator installation 102.

Then in an operation 606 the filtered annotation database is downloaded from operator installation 102 to client terminal 100.

In an operation 607 the annotation software is then implemented in association with the filtered annotation database downloaded onto client terminal 100.

Then in an operation 608 for consulting a content provider site 101 by client terminal 100 the annotation software polls for the presence of data which, using semantic criteria, can be associated with key words of the downloaded filtered annotation database.

When the annotation software detects the presence of data which, using semantic criteria, can be associated with key words of the filtered annotation database it displays the matching annotation extracted form the filtered annotation database on the screen of client terminal 100 in an operation 609.

In one modification, of operation 609 the annotation software asks users of client terminal 100, firstly, whether they want an annotation to be displayed or not. In the affirmative the matching annotation is displayed. In the negative the matching annotation is not displayed.

In a first modification of the protocol the filtering operation is not performed by annotation provider installation 103 but by operator installation 102 that should then be informed of the user's profile, said profile having then been obtained via annotation provider installation 103 or directly by client terminal 100. In this modification annotation provider installation 103 transmits a complete annotation database to operator installation 102 in operation 605 before said operator installation performs the operation involving filtering and constructing a filtered database followed by operation 606 in which the filtered database thus constructed is transmitted to client terminal 100.

In a second modification installations 102 and 103 transmit a complete annotation database in operations 605 and 606 and the filtering operation is performed by the annotation software on client terminal 100 on the fly (which does not imply the construction of a filtered annotation database) or when the complete database is received (which implies the construction of a filtered annotation database). It should be noted that in this second modification the user profile can be defined locally in terminal 100.

In one modification, when the complete or filtered annotation database contains only references to annotations and when the annotation software detects the presence of data which, using semantic criteria, can be associated with key words of the annotation reference database (either complete or filtered) client terminal 100 makes an annotation request to annotation provider installation 103 containing a reference to the matching annotation extracted from the annotation database (in particular this reference may be a URL address type or an index in an annotation table). Annotation provider installation 103 then sends the referenced annotation to client terminal 100 that then displays the annotation received.

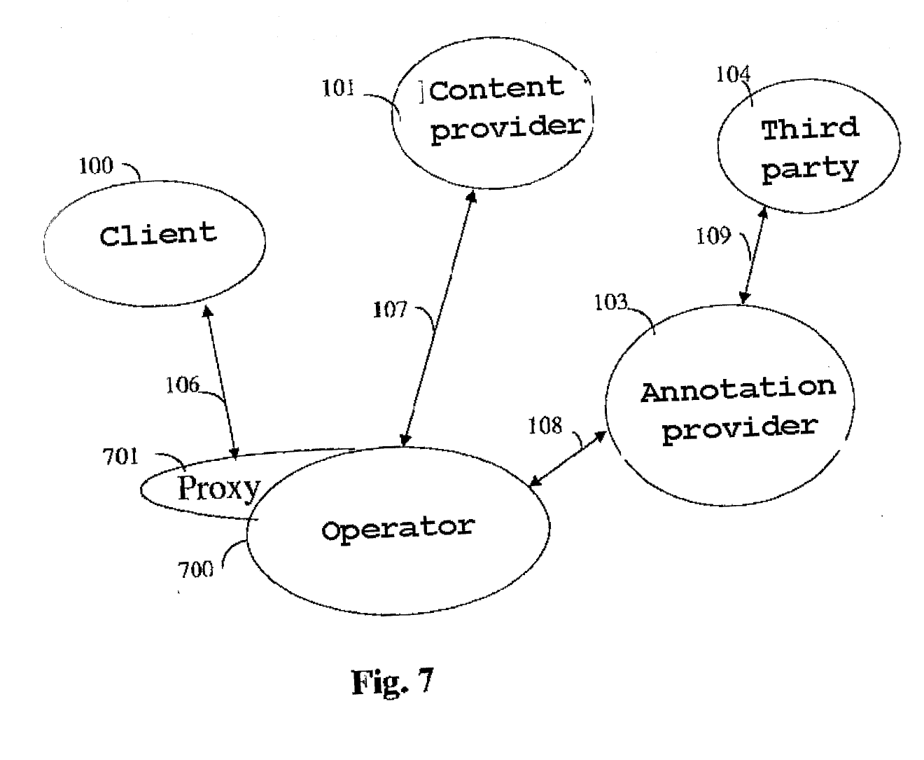

In relation to FIG. 7 a version of the telecommunications network infrastructure is presented as described relative to FIG. 1.

The parts common to both FIGS. 1 and 7 bear the same references and are not further described below.

It should be noted, however, that, in particular, the infrastructure comprises the following:

a client terminal 100;

a content provider Internet site 101;

an operator installation 700;

an annotation provider installation 103;

a third-party terminal 104.

In addition, it should be noted that links:

109 between terminal 104 and installation 103;

108 between installation 103 and operator installation 700;

107 between site 101 and operator installation 700; and

106 between terminal 100 and installation 700; are maintained.

On the other hand, the direct link between client terminal 100 and site 101 is no longer necessary.

In particular, operator installation 700 comprises a proxy 701 or gateway.

In the embodiment of the invention based on the infrastructure version described relative to FIG. 7 the data from site 101 is transmitted by link 107, operator installation 700 and its proxy 701 and link 106 before it is processed or displayed by client terminal 100.

In this embodiment the annotations are displayed identically on client terminal 100 according to the two types of infrastructure described relative to FIGS. 1 and 7. Nevertheless, the annotations are made available according to two different protocols.

FIG. 8 is a communication protocol that implements an annotation proposal to client terminal 100, as shown relative to FIG. 7.

In an operation 600 operator installation 102, via site 400 shown in relation to FIG. 4, and annotation provider installation 103, via site 402, propose an annotation service to client terminal 100.

In an operation 601, client terminal 100 takes out an annotation service subscription from annotation provider installation 103 via operator installation 700 and defines, if appropriate, its profile by selecting proposal 413 and/or 414. There may be a charge for the annotation service or it may be free. If there is a charge a payment operation is performed according to any mode of payment.

In an operation 800, proxy 701 of operator installation 700 then updates a first list of subscribers.

Then in an operation 602 annotation provider installation 103 updates its database containing a second list of subscribers.

In an operation 801 the complete annotation database is then downloaded from annotation provider installation 103 to proxy 701. It should be noted that proxy 701 can be connected to several client terminals that do not necessarily have the same profile. In this event proxy 701 requires, according to a preferred embodiment, an annotation database that includes all the data likely to be of use to the clients according to their profile, in other words a complete database.

In one modification, proxy 701 only uses one annotation database filtered by annotation provider installation 103. In this event annotation provider installation 103 knows the profiles of the client terminals connected to the proxy due to the subscriptions that were previously taken out in operation 601 or due to a request that was previously emitted by proxy 701 specifying the filter that should be applied to the complete annotation database of annotation provider installation 103 in order to obtain a filtered annotation database that will be transmitted to proxy 701. According to this version a filtered annotation database is transmitted by annotation provider installation 103.

Once operation 801 has been performed (according to the preferred embodiment or modification described above) in an operation 802 client terminal 100 consults an Internet content provider site 101 via links 106 and 107 described in relation to FIG. 7.

Then in an operation 803 the consulted data is transmitted by content provider site 101 to proxy 701 via link 107 described in relation to FIG. 7.

In an analysis operation 804 the consulted data is then transmitted by proxy 701 that detects the presence of data which, using semantic criteria, can be associated with key words of the filtered annotation database. When the presence of such data is detected proxy 701 modifies the consulted data before relaying it to client terminal 100. The proxy therefore adds matching annotations to the annotations detected. Depending on the type of application it can also extract consulted data or modify the presentation. It can also insert an active code on the fly, i.e. a code that enables an algorithm and/or instructions to be performed by the user's terminal. In particular, the active code can be a script code, an applet or a set of macro instructions. The method can be used that is described in the patent application entitled “Method for optimizing data consultation using an architectural part of the network” that was filed on the same day as the present application by the same applicant. The text of this other application is included in the present document as a reference.

Then in an operation 805 the data updated by proxy 701 comprising the consulted data from site 101 and one or more possible annotations are transmitted to client terminal 100 via link 106 described in relation to FIG. 7.

In a display operation 806 the data updated by proxy 701 is then displayed on the screen of client terminal 100.

In one modification, when the annotation database downloaded from annotation provider installation 103 to proxy 701 in operation 801 does not contain actual annotations but references to annotations and when in analysis operation 804 proxy 701 detects the presence of data which, using semantic criteria, can be associated with key words of the annotation reference database (either complete or filtered), proxy 701 makes an annotation request to annotation provider installation 103 containing a reference to the matching annotation extracted from the downloaded annotation database (in particular this reference may be a URL address or an index in an annotation table). Annotation provider installation 103 then sends the referenced annotation to proxy 701 that then inserts the annotation received in the consulted data before sending it to terminal 100 in operation 805.

The aim of the embodiments described is not to reduce the scope of the invention. Consequently, many modifications may be made while still remaining within the scope of the present invention; in particular, it may be envisaged that the consulted data comes not only from an Internet site but also from any medium, particularly a medium such as a CD-ROM, DVD-ROM or computer floppy disk.

Similarly, the annotation databases and analysis software for consulted data and annotation proposals are not necessarily downloaded via a telecommunications network but can be read on and/or downloaded from any medium, particularly a medium such as a CD-ROM, DVD-ROM or computer floppy disk.

In addition, those skilled in the art may create any number of modifications of the network infrastructure described above. For example, certain parts of the networks described could be combined. In particular, the annotation provider and operator installations can be combined. The annotation provider could also create annotations directly without contacting an annotation creator.

1. Method for consulting data on at least one terminal by at least one user, the consulted data being pages downloaded from remote sites and/or available on a data recording medium characterized in that it comprises a stage for personalizing said pages implementing at least one annotation database that is independent of said pages, said personalization stage comprising the following stages:
associating at least one reference data item, which is capable of being detected among said consulted data, with at least one annotation in said annotation database;
searching for at least one reference data item in said pages or in at least a portion of said pages; and
when one of said reference data items is detected in said search stage among said consulted data, systematically proposing the at least one associated annotation in said annotation database to said detected reference data item.

2. Consultation method of claim 1, characterized
in that the stage in which at least one reference data item is associated with at least one annotation comprises a stage in which one semantic link criterion, which consists of at least one reference word, is associated with each annotation of the annotation database;
and in that the search stage comprises a search of at least one semantic link of said semantic link criterion to said at least one reference data item likely to be detected among said consulted data.

3. Consultation method of claim 2, characterized in that the stage in which at least one reference data item is associated with at least one annotation comprises a stage in which said annotation database is constructed from data provided by at least one annotation creator.

4. Consultation method of claim 2, characterized in that said proposal stage comprises at least one of the following stages:
indicating the possibility of providing an annotation associated with said at least one reference data item detected in said search stage;
on request from said at least one user, providing, in the strict sense of the term, an annotation associated with said at least one reference data items detected in said search stage.

5. Consultation method of claim 2, characterized in that said method also comprises the following stages for each user:
defining a user profile enabling the annotations made available to said user to be limited to selected annotations included in a specific selection group comprising annotations of possible interest to said user; and
selecting annotations according to said user profile such that only said selected annotations are proposed to the user in said proposal stage.

6. Consultation method of claim 1, characterized in that the stage in which at least one reference data item is associated with at least one annotation comprises a stage in which said annotation database is constructed from data provided by at least one annotation creator.

7. Consultation method of claim 1, characterized in that said proposal stage comprises at least one of the following stages:
indicating the possibility of providing an annotation associated with said at least one reference data item detected in said search stage;
on request from said at least one user, providing, in the strict sense of the term, an annotation associated with said at least one reference data items detected in said search stage.

8. Consultation method of claim 1, characterized in that said method also comprises the following stages for each user:
defining a user profile enabling the annotations made available to said user to be limited to selected annotations included in a specific selection group comprising annotations of possible interest to said user; and
selecting annotations according to said user profile such that only said selected annotations are proposed to the user in said proposal stage.

9. Consultation method of claim 8, characterized in that said method also comprises a stage for each user in which an annotation sub-database is constructed for said user that comprises only the annotations selected according to said profile of said user.

10. Consultation method of claim 8, characterized in that said profile of said user takes into consideration at least one of the following attributes:
at least one profile of an annotation creator capable of providing data intended to be used to construct an annotation database;
at least one annotation domain; and
at least one profile of an annotation provider.

11. Consultation method of claim 1, characterized in that it also comprises the following stages:
putting at least one user and one annotation provider in contact with each other via an annotation service provider; and
authorizing at least one user access to all or part of said annotation database.

12. Consultation method of claim 1, characterized in that terminal implements the following:
said annotation database, and/or
an annotation sub-database of said user of said terminal comprising only the annotations selected according to the profile of said user, and/or
at least one of the following stages:
said search stage,
a semantic link stage in which a semantic link criterion, which consists of at least one reference word, is associated with each annotation of the annotation database, and
said proposal stage, and
a stage in which at least one profile of said user of said terminal user profile is defined to enable the annotations made available to said user to be limited to selected annotations included in a specific selection group comprising annotations of possible interest to said user.

13. Consultation method of claim 1, characterized in that said consulted data is downloaded via at least one first communications network and/or is available on a data recording medium.

14. Consultation method of claim 1, characterized in that a remote installation connected to said terminal via at least a second communications network that is identical to or different from the first communications network implements the following:
said annotation database, and/or
an annotation sub-database of said user of said terminal comprising only the annotations selected according to the profile of said user, and/or
at least one of the following stages:
said search stage,
a semantic link stage in which a semantic link criterion, which consists of at least one reference word, is associated with each annotation of the annotation database, and
said proposal stage, and
a stage in which at least one profile of said user of said terminal user profile is defined to enable the annotations made available to said user to be limited to selected annotations included in a specific selection group comprising annotations of possible interest to said user.

15. Consultation method of claim 14, characterized in that said remote installation belongs to the group comprising the following:
annotation provider servers,
annotation service provider servers, and
proxy installations included in said second communications network.

16. Consultation method of claim 13, characterized in that said at least first communications network and/or a second communications network is(are) Internet-type network(s) (Web, WAP or derivatives).

17. Consultation method of claim 1, characterized in that an annotation service provider implements the following:
said annotation database, and/or
an annotation sub-database of said user of said terminal comprising only the annotations selected according to the profile of said user, and/or
at least one of the following stages:
said stage in which at least one reference data item is associated with at least one annotation,
said search stage,
said proposal stage,
a semantic link stage in which a semantic link criterion, which consists of at least one reference word, is associated with each annotation of the annotation database,
a stage in which at least one profile of said user of said terminal user profile is defined to enable the annotations made available to said user to be limited to selected annotations included in a specific selection group comprising annotations of possible interest to said user,
a stage in which contact between at least one user and one annotation provider is established via an annotation service provider, and
an access authorization stage authorizing at least one user to all or part of said annotation database.

18. System for consulting data on at least one terminal by at least one user, the consulted data being pages downloaded from remote sites via at least one first communications network and/or available on a data recording medium, characterized in that it comprises means for personalizing said pages implementing at least one annotation database that is independent of said pages, the said personalization means themselves comprising the following means:
means for associating at least one reference data item, which is capable of being detected among the consulted data, with at least one annotation in said annotation database;
means for searching for at least one reference data item in said pages or in at least a portion of said pages; and
when one of said reference data items is detected by said search means in said consulted data, means for systematically proposing the at least one annotation associated in said annotation database with said detected reference data item.

19. Data consultation system of claim 18, characterized in that an annotation service provider implements at least certain of said association, search and/or proposal means in order to provide said at least one user that has said at least one terminal available with an annotation service.

20. Data consultation system of claim 19, characterized in that said annotation service provider comprises means for providing said at least one user with at least certain of the following means via a second communications network that is identical to or different from the first network and/or via a data recording medium:
all or part of said annotation database,
at least one of said search means, and
at least one of said proposal means.
